(19) United States
(12) Patent Application Publication
(10) Pub. No.: US 2022/0027620 A1
(43) Pub. Date: Jan. 27, 2022

(54) DENDRITIC TAGS

(71) Applicant: ARIZONA BOARD OF REGENTS ON BEHALF OF ARIZONA STATE UNIVERSITY, Scottsdale, AZ (US)

(72) Inventor: Michael N. Kozicki, Phoenix, AZ (US)

(21) Appl. No.: 17/311,154

(22) PCT Filed: Dec. 4, 2019
(86) PCT No.: PCT/US2019/064496

§ 371 Date: Jun. 4, 2021

Related U.S. Application Data
(60) Provisional application No. 62/775,065, filed on Dec. 4, 2018.

(51) Int. Cl. G06K 9/00; C25C 5/02; C08G 83/00

(52) U.S. Cl. CPC G06K 9/00577; G06K 2009/0059; C08G 83/004; C25C 5/02

(57) ABSTRACT

Preparing a dendritic tag includes forming a liquid composition including dendrites, separating the dendrites from the liquid composition, and disposing the dendrites on a substrate. In some cases, the composition is applied to a substrate and the liquid is evaporated to yield at least one dendrite in direct contact with the substrate. A labeled item includes an item and a dendritic tag coupled to the item, such that the item can be identified or authenticated based on a property of the dendritic tag.

### CROSS-REFERENCE TO RELATED APPLICATION

This application claims the benefit of U.S. Provisional Application No. 62/775,065 entitled “DENDRITIC TAGS” and filed on Dec. 4, 2018.

### TECHNICAL FIELD

This invention relates to production and use of dendritic tags to prevent counterfeiting and to track items.

### BACKGROUND

Over the last several years, the global value of counterfeit goods has exceeded half a trillion dollars. In addition to direct economic losses to manufacturers, counterfeit materials, parts and assemblies typically provide inferior performance and poor reliability, which can reduce brand integrity and cause safety and security issues. Thus, there is a need for anti-counterfeiting technologies that are highly secure, inexpensive, and compatible with global supply chains. Moreover, there is also a need to identify and track manufactured and agricultural products through production, sale, and use.

### SUMMARY

In a first general aspect, preparing a dendritic tag includes forming a liquid composition including dendrites, separating the dendrites from the liquid composition, and disposing the dendrites on a substrate.

Implementations of the first general aspect may include one or more of the following features.

The liquid composition may be a suspension including the dendrites. Forming the liquid composition may include electrodeposition of the dendrites on a surface. Forming the liquid composition may further include separating the dendrites from the surface. Separating the dendrites from the surface may include sonication, rinsing the surface with a liquid, scraping the dendrites from the surface, or any combination thereof. Separating the dendrites from the liquid composition may include removing the dendrites from the liquid composition, for example, by filtration, centrifugation, or electrophoresis. In some cases, separating the dendrites from the liquid composition includes removing a liquid from the liquid composition. Removing liquid from the liquid composition may include evaporating or wicking the liquid from the liquid composition.

Implementations of the first general aspect may include obtaining an image of the dendrites disposed on the substrate. A property of each of the dendrites may be assessed. Based on the assessed property of each of the dendrites, a subset of the dendrites may be selected for use as dendritic tags. A dendrite selected for use as a dendritic tag may be imaged to yield an image of the dendrite, and a unique identifier may be generated from the image. The dendrite selected for use as a dendritic tag may be coupled to an item. The item may be associated with the image and the unique identifier. Coupling the dendrite to the item may include adhering the dendrite to the item with a polymer. A property of the dendritic tag may be assessed and, based on the assessed property, the item may be identified. Identifying the item may include authenticating the item. In some examples, the item is an item (e.g., a product) that is manufactured, mined, or grown.

In a second general aspect, a labeled item includes an item and a dendritic tag coupled to the item. The item can be identified or authenticated based on a property of the dendritic tag.

In a third general aspect, preparing a dendritic tag includes forming a composition including dendrites and a liquid, applying the composition to a substrate, and evaporating the liquid, thereby separating the dendrites and the liquid to yield at least one dendrite in direct contact with the substrate.

Implementations of the third general aspect may include one or more of the following features.

The composition may be a suspension. Applying the composition to the substrate may include spraying the composition on the substrate or spreading the composition on the substrate. The at least one dendrite in direct contact with the substrate may be imaged to yield an image of the at least one dendrite. The image of the at least one dendrite may be stored in a database together with information identifying the substrate.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

FIGS. 1A and 1B are electron micrographs of silver dendrites grown in ultrapure water on a glass slide using an electrodeposition process with thin-film silver electrodes.

FIG. 2 is a flow chart showing collection and use of free-floating dendrites.

FIG. 3 depicts a sheet of captured dendrites.

FIG. 4 shows an example of a true dendrite.

### DETAILED DESCRIPTION

Dendritic tags described herein are unique complex information-rich elements that are produced and used to prevent counterfeiting and to track items, provide secure access, and enable data encryption. The dendritic tags are intricate branching structures that possess a singular set of minutiae for every instance of formation, much like fingerprints or the patterns in the retina of the eye as used for identification and entry into secure areas. Robust metallic dendrites can be mass-manufactured using electro- or photo-chemical processes, but no two dendrites are alike as the physicochemical processes which form them are stochastic in nature. A radial metal dendrite is one example of a metallic dendrite.

The target applications rely on the uniqueness of the dendrites but also on the ability of the elements to represent very large numbers. The capacity of these patterns to represent information—essentially the extent of their uniqueness—depends at least in part on their fractal dimension, set by the formation conditions, and on a chosen scale factor (related to the magnification used to assess the pattern). Even with a modest reading/evaluation scheme, a very large set of unique tags—sufficient to tag every manufactured, mined, or grown item on Earth—can be generated. This not only has significant utility in physical tagging applications but also in data security, in which the unique and truly random codes derived from the dendrites can be used as highly secure keys in the encryption/decryption of information.

The vast capacity for dendrite generation, an advantage of this approach, can be attributed at least in part to chemical self-assembly, which simplifies manufacturing. As an added advantage, micro- to nano-scale facets of chemically formed dendrites introduce yet another layer of complexity and randomness to the overall structure. The micro- and nano-scale facets can be used to ensure that the dendrite being assessed is itself authentic and not merely a high-resolution two-dimensional (2D) copy. This low cost multi-dimensional unclonability contributes to the suitability for success of dendritic tags in highly secure tagging applications.

Use models for dendritic tags depends on the specific application. In one example, for identification and anti-counterfeiting applications, the item being protected has a single dendritic tag or an ensemble of tags attached as a trust mark. A numerical identifier generated from the pattern in the tag(s) is mapped to information on the item in a searchable secure database. Scanning of the pattern may be performed at various points in the supply chain to verify item authenticity; altered, non-corresponding, or missing patterns would indicate an instance of counterfeiting, tampering, or the like. Dendritic patterns made on the millimeter scale facilitate hand-held optical scanning, which may be performed using devices such as a camera on a regular smart phone, but they can also be as small as a few microns in diameter for covert tagging, multiple tagging with large numbers of elements, and use on or within small items such as integrated circuit packages.

As described herein, dendrites may be grown in a liquid electrolyte, or upon or within a solid electrolyte layer. Growth conditions, including the nature of the growth medium that incorporates the electrolyte, type and molarity/concentration of ions and their oxidation state, and externally applied conditions like voltage, temperature, humidity, influence dendrite morphology (including fractal dimension, branch thickness, diffusive effects that “smear” out the fine features, and the like). Generally, the ion mobility is highest in liquids and lowest in solids because of the increase in the strain energy component of the activation energy. Thus, dendrites tend to grow fast in liquids but may have a more dense morphology due to the high diffusivity of the ions causing the gaps between features to be filled-in. The resulting dendrites are formed in the absence of a substrate or easily detached from the substrate on which they are formed. Dendrites grown in a liquid electrolyte can be free-floating. The dendrites may be formed by electrodeposition reactions and electroless methods. In electrodeposition reactions, electrodes are immersed in an electrolyte, an external voltage or current source is coupled to the electrodes, and the dendrites are grown on the cathode or on a substrate containing the cathode. The dendrites can be subsequently detached from the cathode or the substrate containing the cathode. In electroless methods, no external electrical power is applied, and the redox reactions are chemically or photochemically driven.

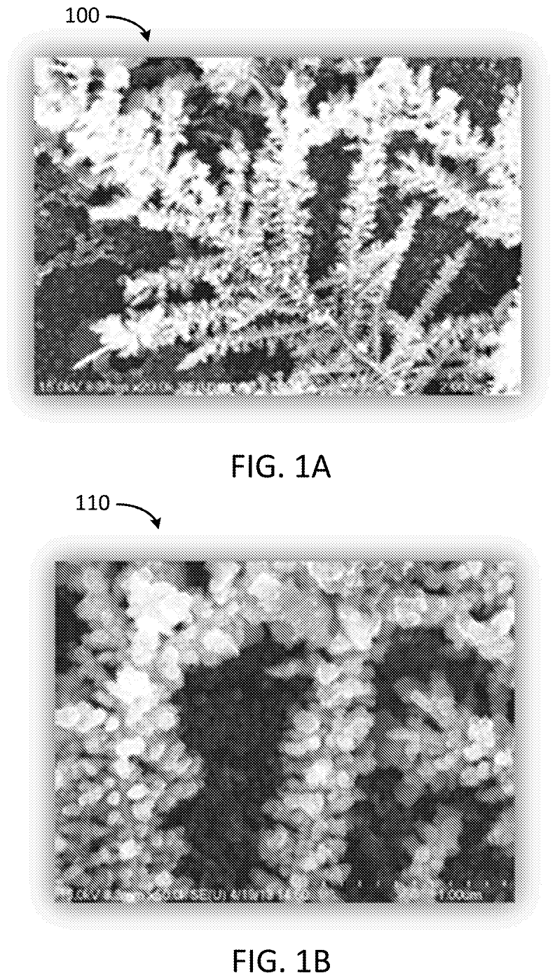

FIGS. 1A and 1B show electron micrographs of silver dendrites 100 and 110, respectively, grown in an electrolyte on a glass substrate having vacuum deposited silver electrodes. In this example, the electrolyte was ultrapure water that contained silver ions dissolved from the electrodes, and the dendrites grew into this solution proximate to or in contact with the cathode on the substrate. The dendrite branches include silver nanoparticles having diameters of a few tens of nanometers (nm), with an average of about 50 nm, which may represent a minimum physical unit for the representation of information for this example. The dendritic structures are three-dimensional (3D) and typically form in a fern-like shape (e.g., the major branches tend to grow in a plane, presumably influenced by the planar form of the underlying substrate). When rinsed with water, the dendrites typically detach from the substrate and free-float in the liquid.

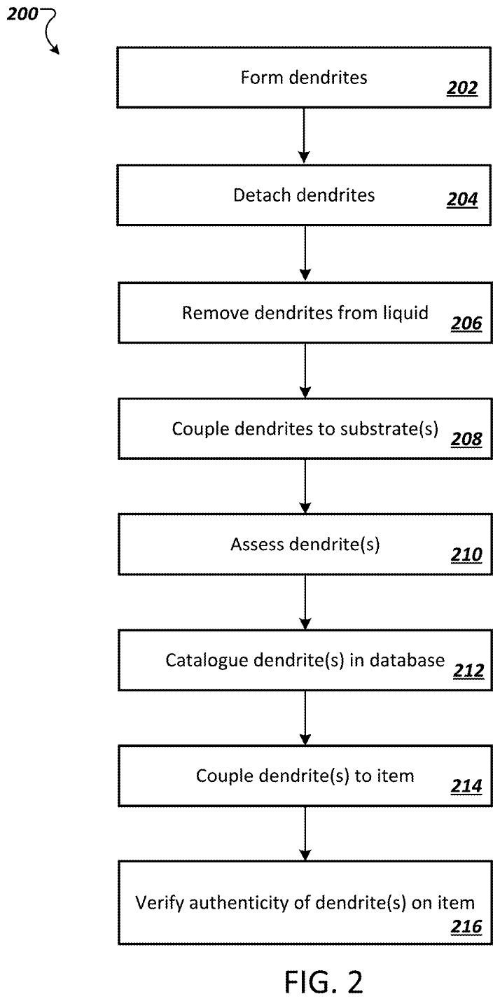

FIG. 2 depicts operations in process 200 for separating free-floating dendrites from the liquid in which they are formed and used as secure tags or taggants (multiple micro-scale tags) in anti-counterfeiting, anti-tampering, or secure track-and-trace applications. Operations in process 200 may be performed in an order other than indicated. In some cases, one or more operations in process 200 may be omitted. In certain cases, process 200 may include one or more additional operations.

In 202, dendrites are formed, for example, by electrodeposition or electroless dendrite growth. If the formed dendrites are in contact with a solid substrate (e.g., an electrode), the dendrites are separated from the solid substrate in 204. Separation from a solid substrate may include rinsing, sonication (e.g., ultrasound), mechanical contact (e.g., blading/scraping), or any combination thereof. After separation, the dendrites are free-floating in a liquid (e.g., electrolyte or rinse liquid). Here, “free-floating” is used to mean that the dendrites are not in contact with or adhered to a solid surface on which they were formed. In some cases, the free-floating dendrites form a suspension.

In 206, the dendrites are removed (or separated) from the liquid using several possible methods. Capturing the dendrites typically includes distributing and immobilizing the dendrites with minimal overlapping or clumping so that they can be assessed, selected, imaged with high resolution, and ultimately used as high-quality tags. In some cases, to help avoid clumping in suspension, agglomeration during extraction, and folding of the dendrites on themselves, a surfactant (e.g., polyvinylpyrrolidone (PVP)) may be added to a dendrite suspension. Separating the dendrites may include extraction of the dendrites from the liquid or removal of the liquid itself.

In 208, the dendrites are coupled to a substrate. In some cases, removing the dendrites from the liquid may include coupling the dendrites to a substrate. In one embodiment, removing the liquid may include evaporating the liquid to leave behind solid metallic dendrites coupled to a suitable substrate that can remain as part of a physical tag if desired. This process can be accelerated by heat, gas flow, or both above the liquid surface. Any salts that are left behind from the evaporated electrolyte can be dissolved in a rinsing step and the substrate re-dried. In another embodiment, liquid in a dendrite suspension may be soaked-up by an absorbent medium (e.g., paper) leaving dendrites coupled to a surface of the absorbent medium.

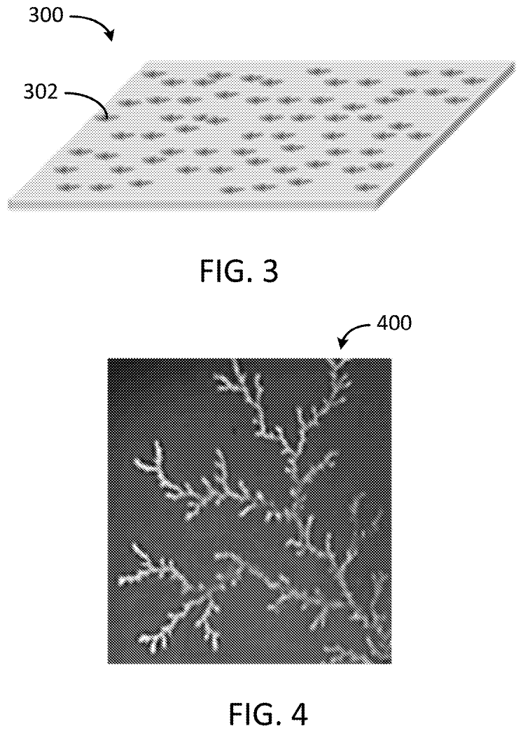

In some cases, separating the dendrites from the liquid include filtration, centrifugation, electrophoresis, or any combination thereof. Filtration typically includes pumping of a dendrite suspension through a membrane filter medium (e.g., cellulose acetate or PTFE) to trap the dendrites on a substrate such as the surface of the membrane as the fluid passes through. The distribution of the dendrites on the substrate can be determined by their density in the suspension (which can be in the order of 10 million per cubic centimeter for photochemical methods) and the flow rate and time of liquid passage through the filter. A low density in suspension (via dilution) coupled with a low flow rate and short time would result in a low area density of dendrites on the membrane surface. Centrifugation typically includes rapid spinning of the suspension so that the relatively heavy metal dendrites are forced to settle on a substrate. The area density in this case would depend on the density of dendrites in the suspension, and the spin rate and time. Electrophoretic dendrite removal typically includes introducing an electric field in the suspension. In one example, a conductive substrate is placed into the liquid along with another electrode (which could also be a capturing substrate or the container holding the suspension) and applying a direct current (DC) or alternating current (AC) voltage between these electrodes to create an electric field that attracts the particles onto the electrode(s). This technique may also be used with a flow of the suspension between the electrodes, using, for example, fields of 16-22 V/cm and a flow rate of the suspension of 2 mL/min or higher. The area density of the dendrites on the substrate depends at least in part on the volume density, the electric field strength, and the flow rate of the suspension. Low volume density, low field, and high flow rate typically result in the lowest area density of dendrites on the substrate. The dendrites may be coupled to the substrate by interfacial adhesion (e.g., van der Waals forces), over-coating with a transparent layer, or other appropriate methods, so that they are protected during assessment, scanning, and use. FIG. 3 depicts sheet 300 with dendrites 302 coupled to a surface of the sheet.

In 210, dendrites coupled to a substrate are assessed for quality to ensure that the patterns are suitable for use. In the case of dendrites for individual use as tags, desirable patterns are typically clear, undamaged, and of the correct fractal form and dimension. For dendrites that will be used as an ensemble in the tagging of an item (e.g., multiple micro-scale dendrites per item), a small percentage of the dendrites can be of poor quality as long as there are sufficient numbers of good patterns in the batch to allow identification of the tagged item.

Assessment typically involves imaging the dendrites and analysis of their shape. True dendrite structures follow a set of rules that qualify them as being so, including: no closed shapes, no crossing line segments, no detached line segments, no retrograde branching (e.g., the angle between a branch and a portion of a corresponding trunk furthest away from its origin is less than 90°), a short/optimized total path length, and a structure that follows a pattern of bifurcating elements that are retained at progressively smaller scales (e.g., pattern is fractal in nature. FIG. 4 shows dendrite 400, which is an example of a true dendrite, electrochemically grown, that embodies these rules. Image analysis can readily identify the features that result from these rules so that true dendrites can be identified and machine learning (ML) may be employed in this process to automate assessment. As part of the image analysis, box counting methods can be employed to determine the fractal dimension of the pattern. The fractal dimension of a pattern can be used to determine the information density of the pattern. In some cases, the fractal dimension is approximately the same for all selected dendrites in a group of dendrites (e.g., on the order of 1.5 to 1.8).

Following assessment and selection of acceptable material, a serialization process may be applied, in which each good dendrite or each good sheet of dendrites has a serial number associated with it to make subsequent information retrieval easier (e.g., the reference image data is retrieved using the serial number and then this is compared to the dendrite being read). In 212, information identifying the dendrite(s) (e.g., a serial number, an image, fractal dimension) is stored or catalogued (e.g., in a database). An image of the dendrite(s) may also be stored or catalogued.

In 214, the dendrite(s) are coupled to an item. The captured dendrites may be used individually or in ensembles to mark a product. For a single dendrite tag, a high-resolution image may be taken of each dendrite and converted to the codes that are unique to this dendrite at various levels of magnification. The higher the level of magnification, the more information that can be extracted, and the larger the numerical representation of the pattern, allowing reading at various “security levels” in the field. Topographic information may also be extracted so that the dendrite itself can be verified in the supply chain. The dendrites may then be incorporated into tags used to protect and track the associated items.

In 216, the authenticity of the dendrite(s) on the item is verified by comparing an image of the dendrite(s) on the item with stored identifier information (e.g., information catalogued in a database).

For an ensemble tag, the entire sheet (or some portion of it) may be imaged together, and then those dendrites applied to the protected item as multiple “micro-tags” on a substrate, which may be the same as or different from the substrate on which the dendrites were captured. In some cases, the dendrites are removed from the substrate using solvents or sonication and then sprayed on the protected item with a carrier/binder/adhesive liquid appropriate to the application (e.g., a food-safe liquid wax or surfactant such a PVP that sticks the small-scale dendrites to an agricultural item). When the provenance or authenticity of the item is subsequently established, a scan of the item would pick up images of some number of the individual dendrites, which would then be compared with the image of the original ensemble. If the found dendrites match individual dendrites within the reference image, the item is verified. For cases in which some dendrites are unusable or unreadable due to manufacturing defects or damage in the field, the scan may be configured to pick up a minimum number to ensure a high degree of confidence and a suitably small error rate. This minimum number may be selected based at least in part on a level of confidence desired, the yield of the manufacturing process, and the likelihood of significant damage or loss in the field.

In one embodiment, separating dendrites from a liquid composition may be achieved by applying the liquid composition onto a substrate (e.g., by painting or spraying) so that the liquid quickly evaporates during application or soon after (due to the large surface area of the liquid), leaving the dendrites on the surface to which the liquid composition is applied. The liquid composition may be a suspension. A suitable process includes forming the dendrites in the liquid composition, applying the liquid composition to a substrate (e.g., an object to be protected), imaging one or more dendrites on the substrate, storing the image in a database along with information on the substrate. This direct use of dendrites from the initial suspension assumes that the quality control/inspection step is unnecessary, and that the protected object can be scanned and the dendrite images captured after application.

In another embodiment, if the dendrites are first grown on a substrate that facilitates their formation (e.g., allows them to nucleate, keeps them substantially flat/2-D), the substrate (or “scaffold”) may be dissolved to release the dendrites into suspension. The substrate may be a non-metallic material (e.g., a polymer such as cellulose acetate) that can be dissolved in an organic solvent (e.g., acetone) without damaging the metallic dendrites. The polymer may be conductive (e.g., polyacetylene, polypyrrole, polyindole or polyaniline) to supply the current for electrochemical dendrite formation.

Another embodiment includes the formation of large numbers of micro-scale dendrites in suspension. These dendrites may be use tag liquids (e.g., pharmaceuticals, alcohol, or other high-value fluids). In this case, the dendrites may be removed from the suspension in which they are formed, imaged as an ensemble on a temporary holding substrate, removed from the temporary substrate, and then introduced into the liquid to be tagged. To verify authenticity or establish provenance at a later time, a sample of the tagged liquid may be obtained and the dendrites in this sample applied to a substrate using methods described herein for dendrite removal. These dendrites may be imaged and compared with the ensemble image for comparison, thereby providing the desired verification.

In other embodiments, imaged dendrites can be introduced into a fluid to allow the tracking of the fluids. In one example, imaged dendrites are introduced into a suspected source of contamination, and water from a nearby waterway can be analyzed for the presence of the introduced dendrites. Identification of an imaged dendrite in water from the waterway using methods described herein for dendrite removal and assessment would establish a fluid connection between the source and the waterway. This embodiment can be used in hydrogeology to map water flow or connectivity of reservoirs.

The dendrite tags may be part of a system that involves front-end (tagging, reading) and back-end (database, comparison) elements. In one example, dendrite tags may be used to identify agricultural products in a process that uses blockchain approaches to the security and usability of the back-end. Dendritic tags may be used to identify discrete items in the food chain (e.g., apples or animal products) by incorporation on existing labels or direct labeling the food product itself. A dendritic tag safe for human consumption may include, for example, less than 1 picogram (pg) silver and PVP as a surfactant or binder. Several hundred of such dendritic tags may be applied to agricultural items to increase the probability of finding a sufficient number for identification purposes, and these could be safely consumed, if not washed off during food preparation. Pharmaceuticals and other products intended for consumption by humans or animals may be similarly identified by dendritic tags.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A method of preparing a dendritic tag, the method comprising:
forming a liquid composition comprising dendrites;
separating the dendrites from the liquid composition; and
disposing the dendrites on a substrate.

2. The method of claim 1, wherein forming the liquid composition comprising dendrites comprises electrodeposition of the dendrites on a surface.

3. The method of claim 2, wherein forming the liquid composition further comprises separating the dendrites from the surface.

4. The method of claim 3, wherein separating the dendrites from the surface comprises sonication.

5. The method of claim 3, wherein separating the dendrites from the surface comprises rinsing the surface with a liquid.

6. The method of claim 3, wherein separating the dendrites from the surface comprises scraping the dendrites from the surface.

7. The method of claim 1, wherein the liquid composition is a suspension comprising the dendrites.

8. The method of claim 1, wherein separating the dendrites from the liquid composition comprises removing the dendrites from the liquid composition.

9. The method of claim 8, wherein removing the dendrites from the liquid composition comprises filtration, centrifugation, or electrophoresis.

10. The method of claim 1, wherein separating the dendrites from the liquid composition comprises removing a liquid from the liquid composition.

11. The method of claim 10, wherein removing the liquid from the liquid composition comprises evaporating or wicking the liquid from the liquid composition.

12-21. (canceled)

22. A labeled item comprising:
an item; and
a dendritic tag coupled to the item, wherein the item can be identified or authenticated based on a property of the dendritic tag.

23. A method of preparing a dendritic tag, the method comprising:
forming a composition comprising dendrites and a liquid;
applying the composition to a substrate; and
evaporating the liquid, thereby separating the dendrites and the liquid to yield at least one dendrite in direct contact with the substrate.

24. The method of claim 23, wherein applying the composition to the substrate comprises spraying the composition on the substrate.

25. The method of claim 23, wherein applying the composition to the substrate comprises spreading the composition on the substrate.

26. The method of claim 23, wherein the composition is a suspension.

27. The method of claim 23, further comprising imaging the at least one dendrite in direct contact with the substrate to yield an image of the at least one dendrite.

28. The method of claim 27, further comprising storing the image of the at least one dendrite in a database together with information identifying the substrate.
